(19) United States
(12) Patent Application Publication
(10) Pub. No.: US 2013/0218761 A1
(43) Pub. Date: Aug. 22, 2013

(54) SYSTEM, METHOD,COMPUTER PRODUCT AND WEBSITE FOR AUTOMOBILE COLLISION REPAIR

(71) Applicant: David J. Kwasny, Elm Grove, WI (US)

(72) Inventor: David J. Kwasny, Elm Grove, WI (US)

(21) Appl. No.: 13/854,770

(22) Filed: Apr. 1, 2013

Related U.S. Application Data
(63) Continuation-in-part of application No. 13/270,066, filed on Oct. 10, 2011, now abandoned.

(51) Int. Cl. G06Q 10/00

(52) U.S. Cl. CPC G06Q 10/20
USPC 705/39; 705/305

(57) ABSTRACT

A system, method, computer product and website for provides full service concierge style vehicle mechanical repair, collision repair, aftermarket installation services and restoration services. The system, method, computer product and website relate to new and improved means for coordinating automobile collision and mechanical repair services. The claimed invention is also adaptable for use with restoration and aftermarket installation services. More specifically, the claimed invention relates to use of a secure website to offer an exclusive, comprehensive and convenient concierge style auto repair solution for modern lifestyle type customers.

### PRIORITY

This application is a continuation in part of U.S. patent application Ser. No. 13/270,066 filed Oct. 10, 2011 which claims the benefit and priority of U.S. Provisional Patent Application No. 61/391,603 filed Oct. 9, 2010.

### FIELD OF THE INVENTION

The claimed invention relates generally to the coordination of automobile collision repair services. It also relates generally to web-based (i.e. utilized by means of the virtual community that exists on the “internet” or within the “world wide web,” or “www”) methods and systems for acquiring, storing, processing, retrieving and displaying information and data, all for providing goods and services to consumers, which is also called “e-commerce.” More specifically, the claimed invention relates to the use of a secure website to offer an exclusive, comprehensive and convenient concierge style auto repair, aftermarket installation and restoration services for modern lifestyle type customers, as well as to the system, method and software product which supports that website.

### BACKGROUND OF THE INVENTION

Today's world of electronic data processing and electronic communications allows vendors, service providers and consumers to electronically interact relative to various products and services via the internet, which is often referred to as “e-commerce.” To add a more robust functionality to services identified as “automobile collision repair services,” or simply “repair services,” using the internet for such e-commerce, this inventor believes that there is a need to develop an interactive product display on a “terminal” whereby repair services can be accessed by the consumer, or “user,” and monitored via the internet. In the experience of this inventor, a typical motor vehicle accident victim, again, the “user,” faces a number of challenges in obtaining competent repair services for his or her automobile. Some of these challenges may include the inconvenience of driving a damaged vehicle to multiple repair facilities to obtain quotes, renting a replacement vehicle, navigating the reimbursement process with insurance companies and even litigation.

### SUMMARY OF THE INVENTION

In accordance with the foregoing, this inventor has devised a repair services functionality that allows a user who is armed with a “terminal,” which is an interactive digital device with or without a touch screen, such as with an iPhone® brand touch-screen device or an iPad® brand tablet computer (iPhone® and iPad® are registered marks of Apple Inc.) that can be used to select options shown on the screen display of such a device. It is to be understood, however, that the electronic page type of the present invention could also be used with traditional personal computers and other personal computing devices, all of which are made accessible using data transmission technology and computing devices, with or without touch screen technology.

In accordance with the present invention, the inventor discloses and claims a unique functionality to be used by a motor vehicle repair facility to assist its customers in navigating the repair process by offering more of a full service, concierge style experience to them. In addition to benefitting consumers, it is anticipated that the repair facilities following the disclosed and claimed system, method, computer product and website will also benefit from increased referral work from happier customers and greater profitability.

It is further envisioned that the disclosed and claimed system, method, computer product and website can be tailored to be used in connection with installers of aftermarket parts as well as for professionals in the restoration business. It is further envisioned that the disclosed and claimed system, method, computer product and website can be tailored for use with vehicle mechanical repair services.

The foregoing and other features of the system, method, computer product and website of the present invention will become apparent from the detailed description that follows.

### BRIEF DESCRIPTION OF THE DRAWINGS

FIG. 1 is a first exemplary screen display of a user “terminal” and showing a home page for a concierge-type website in accordance with the present invention.

FIG. 2 is a second exemplary screen display of the terminal and showing an “on-line” form to be populated by the user.

FIG. 3 is a third exemplary screen display of the terminal and showing a preliminary quote or estimate for the proposed repair services by a repair facility.

### DETAILED DESCRIPTION OF THE INVENTION

As a prefatory statement, it is to be understood that the e-commerce of the present invention is enabled using various types of “terminals.” Examples of such terminals include stationary terminals as well as mobile terminals, including mobile phones, smart phones, computers, digital broadcast terminals, personal digital assistants and portable multimedia players. Stationary terminals are typically desk top terminals that are hard wired to a communication port or wirelessly connected to a modem, the modem being connected wirelessly or hard wired via cables or optical fiber bundles to a communication network. For purposes of this disclosure, it will be assumed that the use of the system, method, computer product and website of the present invention will be with regard to a mobile terminal, but it should be noted that such teachings apply equally to other types of terminals, including stationary terminals in accordance with known art. The key principle of the present invention, however, is to provide users with a digital good that is associated with a physical service, which is motor vehicle repair.

The mobile terminal in accordance with the preferred embodiment of the present invention can include a wireless communication unit, an audio/video input unit, a user input unit, a sensing unit, an output unit, a memory, an interface unit, a controller, a power supply unit and the like. It is also to be understood that implementing all of the components is not a requirement as greater or fewer components may be implemented.

The wireless communication unit typically includes one or more components which permits wireless communication between the mobile terminal and a wireless communication system or network within which the mobile terminal is located. For instance, the wireless communication unit can include a broadcast receiving module, a mobile communication module, a wireless internet module and the like. The broadcast receiving module receives a broadcast signal and/or broadcast associated information from an external broadcast managing server via a broadcast channel. The broadcast channel may include a satellite channel and a terrestrial channel. The broadcast managing server generally refers to a server which generates and transmits a broadcast signal and/or broadcast associated information or a server which is provided with a previously generated broadcast signal and/or broadcast associated information and then transmits the provided signal or information to a terminal. The broadcast associated information includes information associated with a broadcast channel, a broadcast program, a broadcast service provider, etc. The broadcast associated information can be provided via a mobile communication network. In this case, the broadcast associated information can be received by the mobile communication module. The broadcast associated information can be implemented in various forms. For instance, broadcast associated information may include an electronic program guide of digital multimedia broadcasting and electronic service guide of digital video broadcast-handheld. The broadcast receiving module may be configured to receive broadcast signals transmitted from various types of broadcast systems. The broadcast signal and/or broadcast associated information received by the broadcast receiving module may be stored in a suitable device, such as a memory. The mobile communication module transmits/receives wireless signals to/from one or more network entities (e.g., base station, external terminal, server, etc.). Such wireless signals may represent audio, video, and data according to text/multimedia message transceivers, among others. The wireless internet module supports Internet access for the mobile terminal. This module may be internally or externally coupled to the mobile terminal. In this case, the wireless Internet technology can include Wireless LAN, Wi-Fi, Wibro, Wimax, HSDPA, etc.

The user input unit generates input data responsive to user manipulation of an associated input device or devices. Examples of such devices include a keypad, a dome switch, a touchpad (e.g., static pressure/capacitance), a jog wheel, a jog switch, etc.

The output unit generates outputs relevant to the senses of sight, hearing, touch and the like. Further, the output unit includes a display which is typically implemented to visually display (output) information associated with the mobile terminal. For example, if the mobile terminal is operating in a phone call mode, the display will generally provide a user interface (UI) or graphical user interface (GUI) which includes information associated with placing, conducting, and terminating a phone call. As another example, if the mobile terminal is in a video call mode or a photographing mode, the display may additionally or alternatively display images which are associated with these modes, the UI or the GUI. The display module may be implemented using known display technologies including, for example, a liquid crystal display (LCD), a thin film transistor-liquid crystal display (TFT-LCD), an organic light-emitting diode display (OLED), a flexible display and a three-dimensional display. Some of the above displays can be implemented in a transparent or optical transmittive type, which can be named a transparent display. Where the display and a sensor for detecting a touch action (hereinafter called “touch sensor”) configures a mutual layer structure (hereinafter called “touchscreen”), it is able to use the display as an input device as well as an output device. In this case, the touch sensor can be configured as a touch film, a touch sheet, a touchpad or the like. The touch sensor can be configured to convert a pressure applied to a specific portion of the display or a variation of a capacitance generated from a specific portion of the display to an electric input signal. Moreover, it is able to configure the touch sensor to detect a pressure of a touch as well as a touched position or size. If a touch input is made to the touch sensor, a signal corresponding to the touch is transferred to a touch controller. The touch controller processes the signal and then transfers the processed signal to the controller. Therefore, the controller is able to know whether a prescribed portion of the display is touched. A proximity sensor can be provided to an internal area of the mobile terminal enclosed by the touchscreen or around the touchscreen. The proximity sensor is the sensor that detects a presence or non-presence of an object approaching a prescribed detecting surface or an object existing around the proximity sensor using an electromagnetic field strength or infrared ray without mechanical contact. Hence, the proximity sensor has durability longer than that of a contact type sensor and also has utility wider than that of the contact type sensor. The proximity sensor can include one of a transmittive photoelectric sensor, a direct reflective photoelectric sensor, a mirror reflective photoelectric sensor, a radio frequency oscillation proximity sensor, an electrostatic capacity proximity sensor, a magnetic proximity sensor, an infrared proximity sensor and the like. In case that the touchscreen includes the electrostatic capacity proximity sensor, it is configured to detect the proximity of a pointer using a variation of electric field according to the proximity of the pointer. In this case, the touchscreen (touch sensor) can be classified as the proximity sensor.

The memory unit, which is a database, is generally used to store various types of data to support the processing, control, and storage requirements of the mobile terminal. Examples of such data include program instructions for applications operating on the mobile terminal, contact data, phonebook data, messages, audio, still pictures, moving pictures, etc. Further, a recent use history or a cumulative use frequency of each data (e.g., use frequency for each data set) can be stored in the memory unit. The memory may be implemented using any type or combination of suitable volatile and non-volatile memory or storage devices including hard disk, random access memory (RAM), static random access memory (SRAM), electrically erasable programmable read-only memory (EEPROM), erasable programmable read-only memory (EPROM), programmable read-only memory (PROM), read-only memory (ROM), magnetic memory, flash memory, magnetic or optical disk, multimedia card micro type memory, card-type memory (e.g., SD memory, XD memory, etc.), or other similar memory or data storage device. The mobile terminal is able to operate in association with a web storage for performing a storage function of the memory on the Internet.

The interface unit is implemented to allow for communication over a computer network, which couples the mobile terminal with external devices. The interface unit receives data from the external devices or is supplied with the power and then transfers the data or power to the respective elements of the mobile terminal or enables data within the mobile terminal to be transferred to the external devices. The interface unit may be configured using a wired/wireless headset port, an external charger port, a wired/wireless data port, a memory card port, a port for coupling to a device having an identity module, audio input/output ports, video input/output ports, an earphone port and/or the like.

The controller typically controls the overall operations of the mobile terminal. For example, the controller performs the control and processing associated with voice calls, data communications, video calls, etc. The controller may include a multimedia module that provides multimedia playback. The multimedia module may be configured as part of the controller, or implemented as a separate component. The controller is able to perform a pattern recognizing process for recognizing a writing input and a picture drawing input carried out on the touchscreen as characters or images, respectively.

It should also be understood that various embodiments described herein may be implemented in a computer-readable medium using, for example, computer software, hardware, or some combination thereof. For a hardware implementation, the embodiments described herein may be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described herein, or a selective combination thereof. Such embodiments may also be implemented by the controller.

For a software implementation, the embodiments described herein may be implemented with separate software modules, such as procedures and functions, each of which perform one or more of the functions and operations described herein. The software codes can be implemented with a software application written in any suitable programming language and may be stored in memory such as the memory, and executed by a controller or processor, such as the controller. That is, the software includes source code which is a list of instructions, written in a selected computer language, and then converted into computer machine language, which language the computer uses to build the software “machine” described by the instructions. The software machine is made up of the components referred to above. The source code is a detailed “blueprint” telling the computer how to assemble those components into the software machine. Further, the source code is organized into separate files, files are organized into separate modules, and modules are organized into separate functions or routines to accomplish, via pre-programmed algorithms, the necessary steps in accordance with the method and system of the present invention. It is to be understood that the specific way that the source code is organized into files, modules and functions is a matter of programmer design choice and is not a limitation of the present invention. It should also be understood that the present invention is made possible by virtue of the existence of the internet.

Lastly, the power supply unit provides power required by the various components for the mobile terminal. The power may be provided internally, externally or a combination thereof.

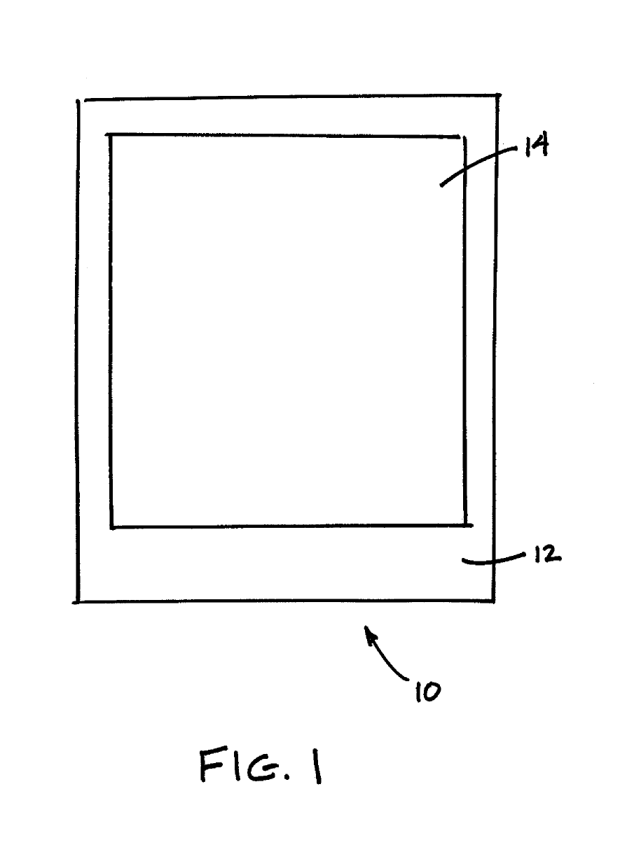

The claimed invention provides a system, method, computer product and website for providing full service concierge style vehicle mechanical repair, collision repair, aftermarket installation services and restoration services. As previously mentioned, those services may also be collectively identified herein as “automobile collision repair services,” or simply “repair services.” Referring to FIG. 1, the mobile terminal, generally identified 10, includes a case 12 (casing, housing, protective cover, etc.) configuring an exterior structure. In this particular embodiment, as would be true with any embodiment, various electric/electronic parts are loaded in a space provided within the case 12. A display, or touch pad, 14 occupies most of a main face of the case 12. Visual information can be displayed on the display 14 and can be displayed in characters, numerals, symbols, graphics, icons, indicia and the like. In order to input information, at least one of the characters, numerals, symbols, graphics, icons and indicia are represented as a single predetermined array to be implemented in a keypad formation. This keypad formation can be so-called “soft keys.” The display or touchpad 14 can be configured to receive a touch input by scroll. A user scrolls the display or touchpad 14 to shift a cursor or pointer located at an entity (e.g., icon or the like) displayed on the display 14. Furthermore, in case that a finger is shifted on the display or the touchpad 14, a path of the shifted finger can be visually displayed on the display 14. This may be useful in editing an image displayed on the display 14.

In accordance with the present invention, the inventor provides a unique functionality to be used to interact with a screen display 14. More specifically, it will be seen that the claimed method provides a screen display 14 for a concierge-type web site for users or customers in need of automobile repair services, aftermarket installation services or restoration services, or simply “repair services.” Customers in need of such services, for example automobile collision damage repair services, are referred to and can log onto a web site via the screen display 14 to schedule the repair services and to receive updates regarding the repair services. The web site can be configured to be accessible via the personal data device 10 or is accessible via the internet.

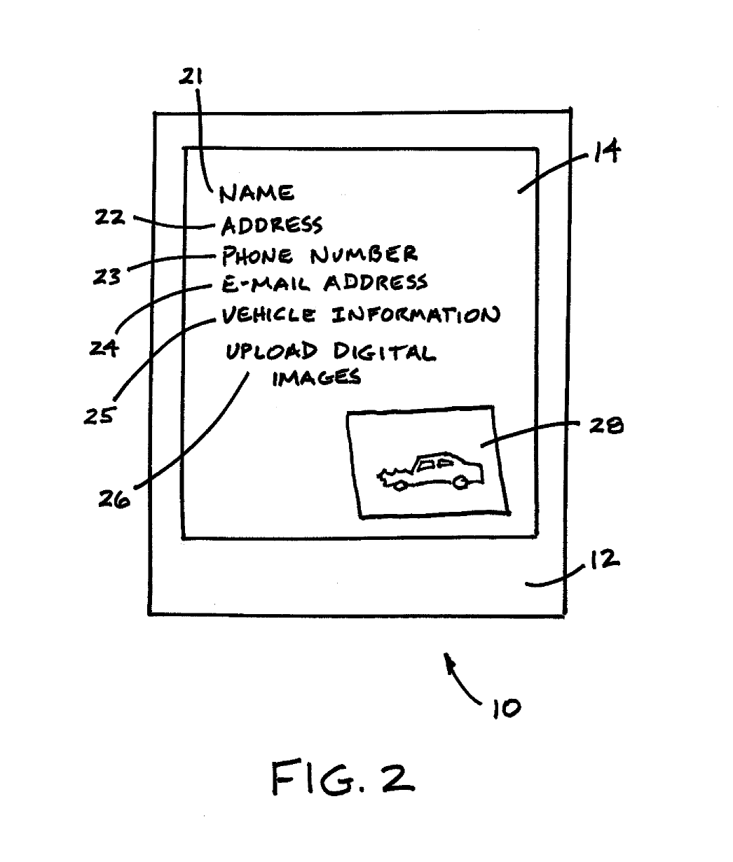

Once at the site, the customer is provided a “virtual” or online form 20 that prompts the user to provide his or her name 21, address 22, phone number 23, internet email address 24 and vehicle information 25. See FIG. 2. The site further provides an option 26 for the user to attach digital images of a crash damaged vehicle and then to submit the vehicle information 26 as well as any pictures 28 to the website for a preliminary estimate of repair costs.

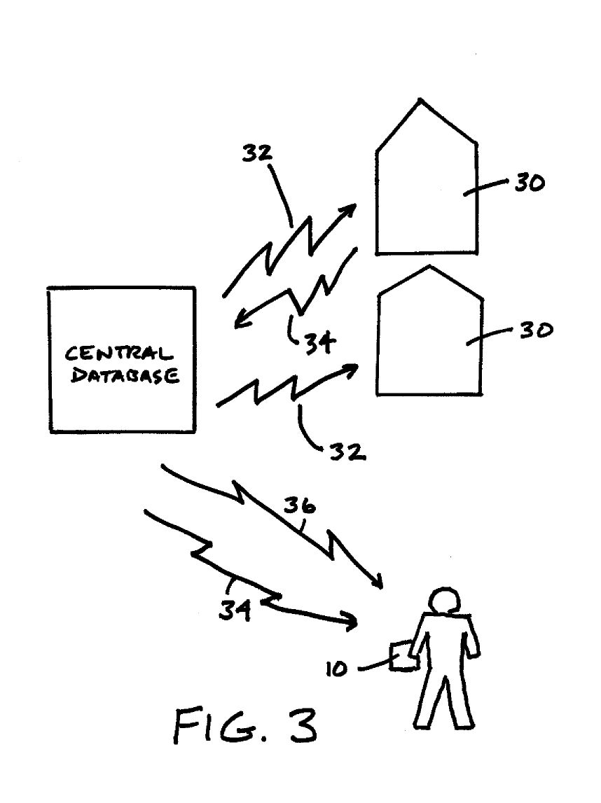

Upon submission of the consumer-supplied information mentioned above, the information is distributed electronically to participating collision repair facilities 30 together with a request for a repair estimate 32. See FIG. 3. Upon receipt of the estimate request 32, the participating collision repair facilities 30 can process the estimate and reply to the customer with the preliminary quote or estimate 34 and with an invitation to repair 36. Alternatively, the collision repair facility 30 can request additional information 26 or photographs 28 from the customer or potential customer.

The consumer has the opportunity to view a number of qualified collision facilities 30 and choose one based on customer ranking, feedback and industry certifications. The customer initiates the request for repair based on his or her choice, which starts the process of the concierge “solution,” which is at the heart of the present invention. In this way, the customer chooses the facility.

Once the consumer accepts the preliminary estimate 34, some additional information may be required of the customer, for which the customer will be prompted to provide. For example, the method and system of the claimed invention could provide various options for scheduling repairs, rental or temporary replacement cars, and pickup and drop off services, among other things. In this way, the facility can choose the time for making repairs which maximizes the facility's efficiency. In other words, other accoutrement services under the method of the present invention allow the facility to repair the auto on its schedule instead of on the schedule of the customer.

Additional features could include electronic review and execution of repair related paperwork, vehicle repair lien documents as well as rental agreements for car rentals. The claimed method would also provide several payment options including but not limited to credit card and cash payments.

Once the vehicle repair process has commenced, and as another part of the concierge process, the website provides an update service for the consumer. The update functionality can be provided via the electronic media of the consumer's choice, whether via secure log-in to the website itself, text message, email, Twitter® (Twitter is a registered mark of Twitter, Inc.), Facebook® (Facebook is a registered mark of Facebook, Inc.) or other social media. Such a repair process might include everything from acknowledging receipt of an order to delivery of the finished vehicle.

Additional intermediate steps may include: an opt in/opt out request so that consumers can determine which updates they want and how they would like to receive their updates; when the car has been retrieved for work, when repair parts are matched to the car; when vehicle structural repair begins or is completed; when vehicle body repair begins or is completed; when vehicle assembly or reassembly begins or is completed; when vehicle paint preparation and vehicle painting begins or is completed; and when the final vehicle has completed the final inspection process. Additionally, the claimed a system, method, computer product and website envisions the use of photographic proof of progress at each individual stage.

Another significant advantage of the present invention is that the facility can, through its associated vendors, offer other car improvement products during the time period that the vehicle is in the shop. Those could include new windshield wiper blades, tires and other consumables. Again, this functionality is built into the website for the mutual benefit of the user, the facility and the vendor, all as part of the concierge experience to the user.

The claimed invention can also provide for vehicle delivery scheduling including scheduling the return of a replacement vehicle and scheduling a pickup time for the vehicle. The claimed invention also provides for customer follow-up by one of the selected means for communication, that is, text, email or Facebook®. The claimed method may further include the use of surveys to obtain customer feedback.

In accordance with the foregoing, it will be understood that there has been provided a new and nonobvious a system, method, computer product and website for providing full service concierge style vehicle mechanical repair, collision repair, aftermarket installation services and restoration services. Various modifications may be made without departing from the spirit and scope of the invention.

What is claimed is:

1. An e-commerce system for providing concierge style automobile collision repair services, comprising:
a server having an interface for communicating over a computer network, wherein the interface comprises at least one graphical user interface including a display and a selection device;
a database having a region of memory where data related to various types of vehicle repair is stored; and
a website configured to facilitate access to the database;
wherein a user enters personal information, vehicle information and vehicle damage information via the website;
wherein the user's personal information, vehicle information and vehicle damage information is transmitted to at least one vehicle repair facility;
wherein the at least one vehicle repair facility prepares and transmits a preliminary repair estimate to the user, such estimate being accessible to the user via the user interface;
wherein the user selects, at his or her option, the at least one vehicle repair facility to perform the repair work;
wherein the at least one facility is able to choose the time that best fits within its schedule for performance of the repair work;
wherein the at least one facility is able to offer accoutrements to the user during the repair process; and
wherein the at least one vehicle repair facility updates the progress of vehicle repair, such update being accessible to the user via the user interface.

2. The system of claim 1 further comprising a website utility for uploading pictures of a damaged vehicle.

3. The system of claim 1 further comprising a website utility for providing online scheduling of repairs.

4. The system of claim 1 further comprising a website utility for providing online reservations for rental or temporary replacement cars.

5. The system of claim 1 further comprising a website utility for providing online reservations for user pickup and drop off services.

6. The system of claim 1 further comprising a website utility for providing online review and execution of repair related paperwork, vehicle repair lien documents as well as rental agreements for car rentals.

7. The system of claim 1 further comprising a website utility for providing online payment processing.

8. The system of claim 1 further comprising a website utility for providing electronic update services for the user.

9. The system of claim 8 wherein the electronic media available for use in communicating updates comprise social media via text message, email, Twitter or Facebook.

10. An e-commerce method for providing concierge style automobile collision repair services generally comprising the steps of:
providing a web site;
compiling a database of vehicle repair facilities;
providing a website for entry of consumer information by a consumer comprising personal information, vehicle information and vehicle damage information via the web site;
directing the consumer information provided by the consumer to the vehicle repair facilities;
transmitting preliminary repair estimates generated by the vehicle repair facilities to consumers;
allowing the user to select, at his or her option, a vehicle repair facility to perform the repair work;
allowing the repair facility to choose the time that best fits within its schedule for performance of the repair work;
allowing the repair facility to offer accoutrements to the user during the repair process; and
providing updates on the progress of repairs to consumers.

11. The method of claim 10 further comprising the step of providing a website utility for uploading pictures of a damaged vehicle.

12. The method of claim 10 further comprising the step of providing online scheduling of repairs.

13. The method of claim 10 further comprising the step of providing online reservations for rental or temporary replacement cars.

14. The method of claim 10 further comprising the step of providing online reservations for consumer pickup and drop off services.

15. The method of claim 10 further comprising the step of providing online review and execution of repair related paperwork, vehicle repair lien documents as well as rental agreements for car rentals.

16. The method of claim 10 further comprising the step of providing online payment processing.

17. The method of claim 10 further comprising the step of providing update services via the customer's electronic media of choice.

18. The method of claim 17 wherein the electronic media available for use in communicating updates comprise social media via text message, email, Twitter or Facebook.

19. The method of claim 10 wherein each step is presented via a webpage on the website.

20. A computer-readable medium encoded with a computer program for causing a computer to perform the method of claim 10.
